(19) United States
(12) Patent Application Publication
(10) Pub. No.: US 2005/0122386 A1
(43) Pub. Date: Jun. 9, 2005

(54) Electrochemical signal amplification by repetitive activation of surface nucleation points

(76) Inventor: Seiji Inaoka, Campbell, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/727,840

(22) Filed: Dec. 3, 2003

(51) Int. Cl. G01N 27/26

(52) U.S. Cl. 347/163; 205/109; 205/316

(57) ABSTRACT

A method of electrochemical imaging including providing at least one target complex disposed on a conductive substrate, exposing the target complex to a solution of image nanoparticles, and repeatedly applying a voltage to the conductive substrate to cause the deposition of the image nanoparticles on the target complex to form at least one image complex.

### FIELD OF THE INVENTION

The present invention relates to electrochemical signal amplification methods for use in the area of electrochemical imaging and particularly in the electrochemical detection of biomolecules.

### BACKGROUND OF THE INVENTION

Array assays between surface bound binding agents or probes and target molecules in solution may be used to detect the presence of particular analytes in the solution. The surface-bound probes may be nucleic acids (e.g., oligonucleotides, polynucleotides), peptides (e.g., polypeptides, proteins, antibodies) or other molecules capable of binding with target biomolecules in the solution (e.g., nucleic acids, proteins, etc.). Such binding interactions are the basis for many of the methods and devices used in a variety of different fields, e.g., genomics (in sequencing by hybridization, SNP detection, differential gene expression analysis, identification of novel genes, gene mapping, finger printing, etc.) and proteomics.

One typical array assay method involves biopolymeric probes immobilized in discrete locations on a surface of a substrate (collectively referred to herein as an “array”) such as a glass substrate or the like. A solution containing target molecules (“targets”) that bind with the attached probes is placed in contact with the bound probes under conditions sufficient to promote binding of targets in the solution to the complementary probes on the substrate to form a binding complex that is bound to the surface of the substrate. The binding by target molecules to probe features or spots on the substrate produces a pattern, i.e., a binding complex pattern, on the surface of the substrate, which pattern is then detected. This detection of binding complexes provides desired information about the target biomolecules in the solution.

The binding complexes may be detected by reading or scanning the array with, for example, an optical means, although other methods may also be used, as appropriate for the particular assay. For example, laser light may be used to excite fluorescent labels attached to the targets, generating a signal only in those spots on the array that have a labeled target molecule bound to a probe molecule. This pattern may then be digitally scanned for computer analysis. Such patterns can be used to generate data for biological assays such as the identification of drug targets, single-nucleotide polymorphism mapping, monitoring samples from patients to track their response to treatment, assessing the efficacy of new treatments, etc.

Electrochemical imaging techniques have been used to facilitate the detection of binding complexes (e.g., deoxyribouncleic acid (DNA), ribonucleic acid (RNA), nucleotides, oligonucleotides, nucleosides, proteins, peptides, polypeptides, and antibodies). In general, electrochemical imaging techniques involve the application of a voltage to an electrically conductive substrate in contact with an electrically conductive solution of an organic substance. The charge experienced by the substrate causes the particles of organic substance to deposit onto the substrate. The deposited particles are optically distinguishable from the substrate, and therefore detectable.

Accordingly, there is a continued interest in the development of new techniques for improved electrochemical imaging. Of particular interest are imaging techniques that maximize the number of target nanoparticles used as nucleation points for imaging nanoparticles, and are easy to use, cost effective, and may be employed in the detection of a number of different biomolecules, analytes or the like.

### SUMMARY OF THE INVENTION

The present invention provides methods and systems for electrochemical imaging. Generally, the methods comprise providing at least one target complex disposed on a conductive substrate, exposing at least one target complex to a solution of image nanoparticles, applying a voltage to the conductive support causing the deposition of the image nanoparticles on the at least one target complex to form at least one image complex, and repeating the application of voltage. Also provided are systems and kits that may be used in the practice of the subject invention.

In one particular embodiment of a method of the present invention, the presence of a biomolecule is determined by providing a plurality of target complexes disposed on a conductive substrate, where each target complex comprises a target biomolecule and a target nanoparticle, exposing the plurality of target complexes to a solution of image nanoparticles, applying a voltage to the conductive support causing the deposition of the image nanoparticles on the plurality of target complexes to form a plurality of image complexes, and repeating said application of voltage at least once.

In still another embodiment of a method of the present invention, a plurality of target complexes is disposed on a conductive substrate where each target complex comprises a target biomolecule and a target nanoparticle; the plurality of target complexes is then exposed to a solution containing a plurality of image nanoparticles; a relatively low (or high) voltage is applied to the conductive support causing the deposition of image nanoparticles on at least one of the plurality of target complexes to form at least one nucleation point; and then a relatively high (or low) voltage is applied to the conductive support causing the removal of the image nanoparticles from the nucleation point. The application of a relatively low voltage and then a relatively high voltage (or relatively high voltage followed by a relatively low voltage) is repeated as desired to cause the deposition of the image nanoparticles on the first nucleation point and on additional target complexes to cumulatively form additional nucleation points.

The methods of the present invention may further comprise detecting the at one or more image complexes using one or more of a variety of techniques including, but not limited to, imaging techniques, electronic measurement techniques and mass measurement technique.

The present invention further provides for systems and kits for carrying out the subject methods.

These and other objects, advantages, and features of the invention will become apparent to those persons skilled in the art upon reading the details of the invention as more fully described below.

### BRIEF DESCRIPTION OF THE DRAWINGS

The invention is best understood from the following detailed description when read in conjunction with the accompanying drawings. It is emphasized that, according to common practice, the various features of the drawings are not to-scale. On the contrary, the dimensions of the various features may be arbitrarily expanded or reduced for clarity. In the drawings, like reference numerals designate corresponding parts throughout the several views. Included in the drawings are the following figures:

FIG. 1 is a flow diagram illustrating a representative embodiment of a method of the present invention.

FIGS. 2A-2F illustrate a representative schematic diagram of a method of the present invention.

FIGS. 3A and 3B are graphs plotting the applied voltage and resulting current measurements during the cycle voltammetry method of the present invention as applied to a biosensor system of FIGS. 2A-2F.

FIGS. 4A and 4B are graphs plotting the image nanoparticle deposition current and dissolution currents, respectively, as a function of time for the cycle voltammetry application of FIGS. 3A and 3B.

### DEFINITIONS

Unless defined otherwise, all technical and scientific terms used herein have the same meaning as commonly understood by one of ordinary skill in the art to which this invention belongs. Still, certain elements are defined below for the sake of clarity and ease of reference.

A “biomolecule” as used herein refers to any organic or biochemical molecule, group or species. Exemplary biomolecules comprise peptides, polysccharides, proteins, amino acids and nucleic acids.

A “biomolecule probe” as used herein refers to a biomolecule with known structure and characteristics, by which it interacts with and is used to detect the existence of a target biomolecule. Biomolecule probes may comprise, but are not limited to, deoxyribouncleic acid (DNA), ribonucleic acid (RNA), nucleotides, oligonucleotides, nucleosides, proteins, peptides, polypeptides, and antibodies.

A “target biomolecule” as used herein refers to a molecule that may be present in an unknown sample, and has strong interaction with a biomolecule probe by a target-probe biological interaction. Target biomolecules may comprise, but are not limited to, deoxyribouncleic acid (DNA), ribonucleic acid (RNA), nucleotides, oligonucleotides, nucleotides, proteins, peptides, polypeptides, and antibodies.

A “nanoparticle” as used herein refers to a solid particle typically having a spherical or similar shape with a dimension between about 1 nanometer and about 1000 nanometers.

An “image nanoparticle” as used herein refers to a nanoparticle that has high optical density. Image nanoparticles may be made of metals such as gold, silver, nickel, lead, copper or platinum, or a metal precursor such as gold, silver, nickel, lead, copper or a platinum precursor.

A “target nanoparticle” as used herein refers to a nanoparticle having characteristics which strongly bind to a probe biomolecule. Typically, the surface of a target nanoparticle is modified with a target biomolecule. Target nanoparticles may be made of metals such as gold, silver, nickel, copper, and platinum and metal alloys.

A “complex” as used herein refers to a composite structure created by the combination of one or more biomolecules and/or nanoparticles.

A “biomolecule complex” as used herein refers to a complex that comprises at least a biomolecule probe and a target biomolecule.

An “image complex” as used herein refers to a complex that comprises at least an image nanoparticle that has an optical density recognizable by the naked eye.

A “target complex” as used herein refers to a complex that comprises at least a target biomolecule and at least a target nanoparticle.

A “nucleation point” as used herein is a location on a conductive substrate that serves as the site of a reaction.

The term “nucleic acid” as used herein refers to a polymer composed of nucleotides, e.g., deoxyribonucleotides or ribonucleotides, or compounds produced synthetically (e.g., PNA as described in U.S. Pat. No. 5,948,902 and the references cited therein) which can hybridize with naturally occurring nucleic acids in a sequence specific manner analogous to that of two naturally occurring nucleic acids, e.g., can participate in hybridization reactions, i.e., cooperative interactions through Pi electrons stacking and hydrogen bonds, such as Watson-Crick base pairing interactions, Wobble interactions, etc.

The terms “ribonucleic acid” and “RNA” as used herein mean a polymer composed of ribonucleotides.

The terms “deoxyribonucleic acid” and “DNA” as used herein mean a polymer composed of deoxyribonucleotides.

The term “oligonucleotide” as used herein denotes single stranded nucleotide multimers of from about 10 to about 100 nucleotides and up to about 200 nucleotides in length.

The term “polynucleotide” as used herein refers to single or double stranded polymer composed of nucleotide monomers of generally greater than about 100 nucleotides in length.

The term “monomer” as used herein refers to a chemical entity that can be covalently linked to one or more other such entities to form an oligomer. Examples of “monomers” comprise nucleotides, amino acids, saccharides, peptides, and the like.

The term “oligomer” is used herein to indicate a chemical entity that contains a plurality of monomers. As used herein, the terms “oligomer” and “polymer” are used interchangeably. Examples of oligomers and polymers comprise

polydeoxyribonucleotides (DNA), polyribonucleotides (RNA), other polynucleotides which are C-glycosides of a purine or pyrimidine base, polypeptides (proteins), polysaccharides (starches, or polysugars), and other chemical entities that contain repeating units of like chemical structure.

The terms “nucleoside” and “nucleotide” are intended to comprise those moieties which contain not only the known purine and pyrimidine bases, but also other heterocyclic bases that have been modified. Such modifications comprise methylated purines or pyrimidines, acylated purines or pyrimidines, alkylated riboses or other heterocycles. In addition, the terms “nucleoside” and “nucleotide” comprise those moieties that contain not only conventional ribose and deoxyribose sugars, but other sugars as well. Modified nucleosides or nucleotides also comprise modifications on the sugar moiety, e.g., wherein one or more of the hydroxyl groups are replaced with halogen atoms or aliphatic groups, or are functionalized as ethers, amines, or the like.

The term “substrate” as used herein refers to a surface upon which target complexes associated. The substrates employed in the subject invention are conductive substrates.

### DETAILED DESCRIPTION OF THE INVENTION

The present invention provides methods and systems for electrochemical imaging. Generally, the methods comprise providing at least one target complex disposed on a conductive substrate, exposing the at least one target complex to a solution of image nanoparticles, applying a voltage to the conductive support causing the deposition of the image nanoparticles on the at least one target complex to form at least one image complex, and repeating the application of voltage at least once. Also provided are systems and kits that may be used in the practice of the subject invention.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described.

It must be noted that as used herein and in the appended claims, the singular forms “a”, “an”, and “the” include plural referents unless the context clearly dictates otherwise. Thus, for example, reference to “a nanoparticle” includes a plurality of such nanoparticles and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided might be different from the actual publication dates which may need to be independently confirmed.

As summarized above, the subject invention provides methods of electrochemical imaging. In further describing the subject invention, the subject methods will be described in greater detail, followed by a description of the systems and kits for use in practicing the subject methods.

Methods

An electric potential, which may be generated by a potentiostat, for example, is then applied to the conductive substrate. The voltage applied to the conductive substrate initiates the deposition of the image nanoparticles on the target complexes, forming image complexes on the conductive substrate. Thus, by electrochemical reduction, the target nanoparticles act as nucleation points for the formation of image nanoparticles on the conductive substrate. In other words, the image nanoparticles selectively deposit where the target nanoparticles are disposed on the conductive substrate. As such, the deposition of the image nanoparticles on the target complex is catalyzed by the target nanoparticles. Thereafter, the image nanoparticles deposited on the target complex can be detected using imaging techniques, electronic measurement techniques, and/or mass measurement techniques.

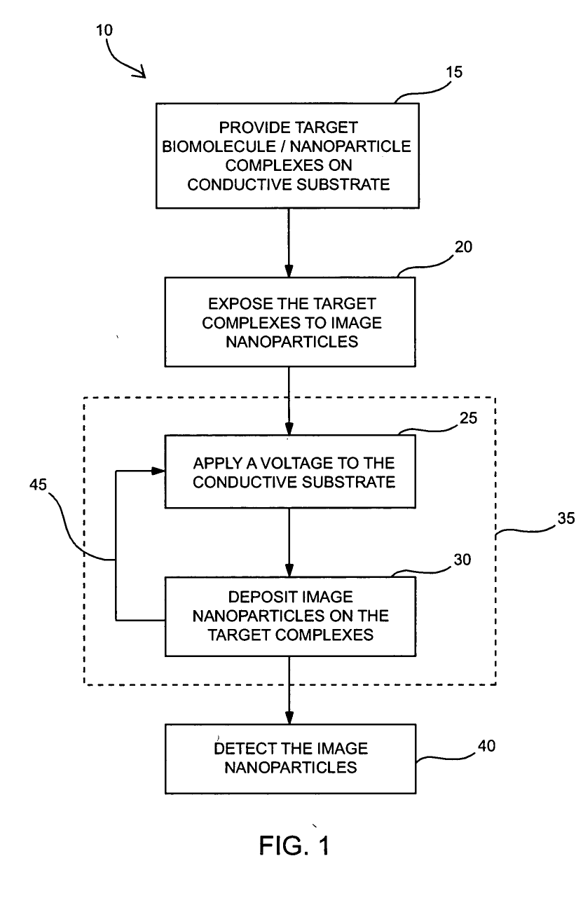

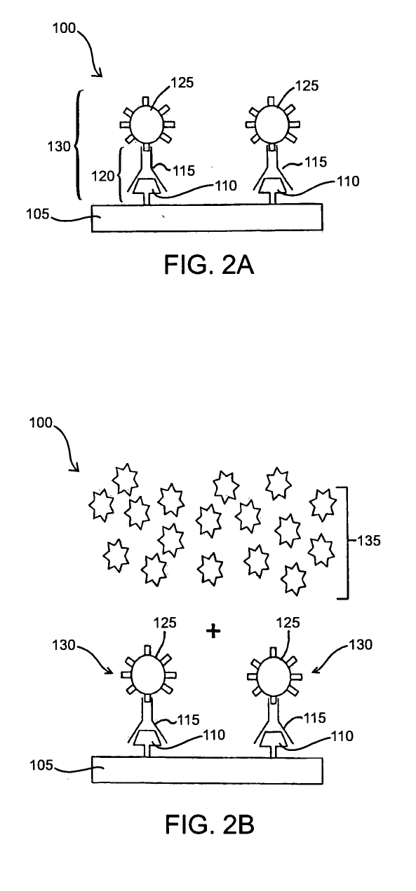

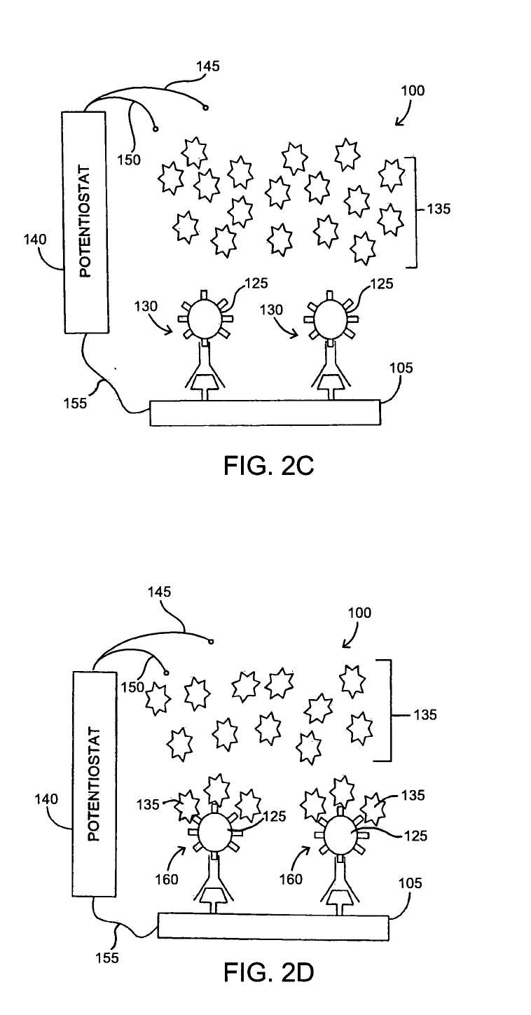

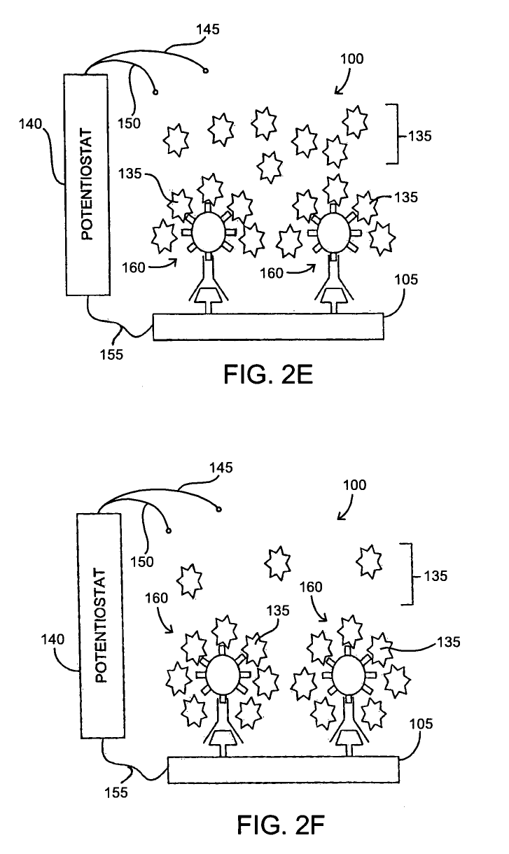

The subject invention is now described in reference to FIG. 1 which is a flow diagram illustrating an exemplary process 10 for determining the presence of a target biomolecule utilizing a target nanoparticle. The various blocks of this flow diagram are schematically illustrated in one or more of FIGS. 2A through 2F.

In block 15 of FIG. 1 and as illustrated in the biosensor system 100 of FIG. 2A, a plurality of target complexes 130 are provided, disposed or formed on a conductive substrate 105. The target complexes 130 are formed by selectively causing a biological and/or chemical interaction to occur between a target biomolecule 115 and a target nanoparticle 125 so as to stably associate a target biomolecule with a target nanoparticle, i.e., a target biomolecule/target nanoparticle complex is formed. See U.S. patent application Ser. No. 10/342,561, herein incorporated by reference in its entirety, for a further description of the formation of target complexes. The target complexes 130 may be formed either prior to deposition on to the conductive substrate 105 or by first depositing the target biomolecule 115 on to the conductive substrate 105 and then causing a target nanoparticle 125 to interact with the target biomolecule 115. Regardless of whether the target biomolecule 115 is deposited onto the conductive substrate 105 before or after being stably associated with a target nanoparticle 125, the deposition of the target biomolecule 115 onto the conductive substrate 105 may be accomplished either indirectly by use of a biomolecule probe 110 (as illustrated in FIG. 2A) or directly without the use of such a probe. The biomolecule probe selectively interacts with target biomolecules 115 (or binding member stably associated thereto) only where complimentary binding sites occur, i.e., where the probe biomolecules 110 and target biomolecules 115 have similar chemical and/or physical characteristics (e.g., nucleotide sequence or amino acid sequence). For example, a biomolecule probe and target biomolecule may comprise members of a specific binding pair. The combination of a biomolecule probe 110 and a target biomolecule 115 is often collectively referred to as a biomolecule complex 120.

The conductive substrate 105 may be designed to have an affinity for different types of probe biomolecule 110 so that multiple types of target biomolecules 115 can be tested at one time. For example, a conductive surface may comprise functional groups that specifically bind certain biomolecules. Furthermore, the surface of the conductive substrate 105 may be designed to interact with specific biomolecule probes 110 at predetermined positions on the conductive substrate 105. As mentioned above, in another embodiment, the conductive substrate 105 may be designed to interact directly with the target biomolecule 115 thereby precluding the need for biomolecule probes 110.

The target biomolecule 115, with or without the use of biomolecule probes 110, and the target nanoparticle 125 interact through selective biological and/or chemical interactions to form a target complex 130 such that a target biomolecule is stable associated with a target nanoparticle. The biological interactions may comprise, but are not limited to, bonding or hybridization among one or more biological functional groups located on the target biomolecule 115 and target nanoparticle 125. The chemical interaction involved in forming a target complex 130 may comprise, but is not limited to, bonding among one or more functional groups (e.g., organic and/or inorganic functional groups) located on the target biomolecule 115 and target nanoparticle 125. Thus, each target complex 130 may comprise, but is not limited to, a biomolecule probe 110, a target biomolecule 115, a target nanoparticle 125, and combinations thereof.

Once a target biomolecule/target nanoparticle complex 130 is stably associated with a conductive substrate, as shown in block 20 and as illustrated in FIG. 2B, the target complexes 130 are exposed to image nanoparticles 135. This is accomplished by introducing a solution of image nanoparticles 135 to the target complexes 130. While an image nanoparticle 135 of any appropriate metal may be used with a target nanoparticle 125 of any appropriate metal, as identified above, the image nanoparticles 135 typically have a higher ionization tendency than the target nanoparticles 125. By higher ionization tendency it is meant that the tendency of the image nanoparticle to ionize is greater than the tendency of the target nanoparticle to ionize under the same conditions. For example, a silver image nanoparticle 135 has a higher ionization tendency than a gold or platinum target nanoparticle 125. Moreover, the image nanoparticles may be selected so that they have a high optical density.

The deposition of the image nanoparticles 135 onto the target complexes 130 involves a chemical reaction between the two that may be facilitated by an electrochemical reduction process (collectively identified as block 35 in FIG. 1). This process is accomplished by applying a voltage potential to the conductive substrate 105, as identified in block 25 and as illustrated in FIG. 2C. The applied voltage may range from a relatively low voltage, e.g., having a magnitude up to about 100 mV (but may be greater) to a relatively high voltage, e.g., having a magnitude of about 2,000 mV (but may be lower), where in many embodiments the voltage employed to facilitate an electrochemical reduction process between an image nanoparticle and a target complex may range from about −2000 mV to about −2000 mV, and usually from about −1500 mV to about 1500 mV, where the particular voltage potential range depends on the type of metal ion that forms image nanoparticles. For example, when a silver ion is used as a precursor for the image nanoparticle, the electrochemical reaction will typically take place at a potential between about −300 mV and about 300 mV.

The voltage potential may be generated in any suitable manner, e.g., the voltage may be generated by a potentiostat, a galvanostat, a battery system capable of supplying appropriate voltages, or by contacting a foreign conductor having a different work function than the conductive substrate 105. In the illustrated embodiment, a potentiostat 140 is used for the application of voltage by employing electrodes including a reference electrode 145, a counter electrode 150 and a working electrode 155. Accordingly, in such embodiments employing a potentiostat, reference electrode 145 and counter electrode 150 are placed in contact with the solution of image nanoparticles 135, and working electrode 155 is placed in contact with conductive substrate 105. A voltage falling within the ranges described above is then generated. While the illustrated embodiment utilizes three electrodes, as few as two electrodes may be used.

In block 30 and as illustrated in FIG. 2D, the voltage applied to the biosensor system 100 initiates the deposition of the image nanoparticles 135 on the target complexes 130, wherein image complexes 160 are formed on the conductive substrate 125. More specifically, the target nanoparticles 125 act as nucleation points for the electrochemical reduction of image nanoparticles 135 on the conductive substrate 105. During application of the voltage, by means of working electrode 155, electrons are caused to buildup on conductive substrate 105. As a result, the positively charged image nanoparticles 135 reduce and selectively deposit onto conductive substrate 105 where the target nanoparticles 125 are disposed on the conductive substrate 105.

In block 40, once the image nanoparticles 135 are disposed on the conductive surface, the image nanoparticles 135 may be detected using imaging techniques, electronic measurement techniques, and/or mass measurement techniques. The detected image of the image nanoparticles 135 disposed on the target complex 130 are related to the image of the target nanoparticle 135, and thus, can be qualitatively identified and/or quantitatively measured. In other words, the detected image of the image nanoparticles 135 disposed on the target complexes 130 corresponds to the biomolecule image of the target nanoparticles 125.

While the electrochemical deposition process of block 35 facilitates the deposition of image nanoparticles 135 and the resulting imaging of image complexes 150, only a limited number of target nanoparticles 125 are being used as nucleation points for the image nanoparticles 135. As is schematically illustrated in FIG. 2D, only a limited number of image nanoparticles 135 have been deposited onto the target nanoparticles 125 after a single application of voltage. Accordingly, a further aspect of the present invention is the use of cyclic voltammetry, i.e., the repetitive voltammetric cycling. Specifically, biosensor system 100 is subjected to repeated applications of voltage, as described above, in order to repeat the electrochemical deposition process of block 35 (indicated by arrow 45 in FIG. 1), as necessary or desired to increase the number of target nanoparticles 125 or target complexes 130 which become activated.

As is schematically illustrated in FIGS. 2E and 2F, repeated application of voltage, e.g., by use of potentiostat 140, progressively increases the number of target nanoparticles 125 that are activated as nucleation sites and increases the density of image nanoparticles 135 which are deposited on those nucleation sites. After each voltammetric cycle or after two or more voltammetric cycles, the deposited image nanoparticles 135 may be detected in the manner discussed above. Any suitable number of voltammetric cycles may be applied to biosensor system 100 or as is necessary to activate a sufficient number of nucleation sites in order to provide a density of image nanoparticles 135 to provide an image that is sufficiently enhanced, i.e., has sufficient darkness or contrast, for the intended purpose. Typically, about 5 to about 50 voltammetric cycles are applied but more or few cycles may be applied as needed.

Systems

The present invention also provides systems for carrying out the above-described methods. The subject systems may comprise one or more conductive substrates configured or adapted for the deposition of target complexes and image nanoparticles thereon and configured or adapted for electrical connection to electrodes, a supply or solution of image nanoparticles, a container means for suitably containing or holding the conductive substrates for the deposition of probes, biomolecules, complexes, and/or nanoparticles or the like, a voltage source and necessary electrodes for connection to the one or more conductive substrates and/or supply or solutions of target complexes and/or image nanoparticles, and means or equipment for detecting the image nanoparticles, such as electrochemical imaging equipment, electronic measurement equipment and mass measurement equipment, and current measuring devices.

Kits

Kits are also provided, as described above, for use in electrochemical imaging in general and for use in electrochemical imaging for purposes of analyte detection in particular. The kits at least comprise a supply or solution of target complexes (or separate supplies of biomolecule probes, target biomolecules and/or biomolecule complexes, and target nanoparticles) and a supply of image nanoparticles. The kits may further comprise one or more substrates for deposition of these compositions thereon.

Such kits also typically comprise instructions for use in performing electrochemical imaging and in practicing array-based assays according to the subject invention. The instructions of the above-described kits are generally recorded on a suitable recording medium. For example, the instructions may be printed on a substrate, such as paper or plastic, etc. As such, the instructions may be present in the kits as a package insert, in the labeling of the container of the kit or components thereof (i.e., associated with the packaging or sub packaging), etc. In other embodiments, the instructions are present as an electronic storage data file present on a suitable computer readable storage medium, e.g., CD-ROM, diskette, etc, including the same medium on which the program is presented.

In yet other embodiments, the instructions are not themselves present in the kit, but means for obtaining the instructions from a remote source, e.g., via the Internet, are provided. An example of this embodiment is a kit that comprises a web address where the instructions can be viewed and/or from which the instructions can be downloaded. Conversely, means may be provided for obtaining the subject programming from a remote source, such as by providing a web address. Still further, the kit may be one in which both the instructions and software are obtained or downloaded from a remote source, as in the Internet or World Wide Web. Some form of access security or identification protocol may be used to limit access to those entitled to use the subject invention. As with the instructions, the means for obtaining the instructions and/or programming is generally recorded on a suitable recording medium.

### EXPERIMENTAL EXAMPLE

The following example is put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g., voltages, currents, etc.) but some experimental errors and deviations should be accounted for.

### Example 1

Two conductive substrates or electrodes made of indium tin oxide (ITO) were provided. One of the ITO electrodes was spotted with a 1 μL of 5 nm gold (Au) nanoparticle dispersion (Sigma-Aldrich, St. Louis, Mo.) and the other ITO electrode was spotted with 1 μL of the same dispersion diluted by 1/1000. The solutions were allowed to dry, wherein the target nanoparticles are immobilized on the respective ITO electrodes. The ITO electrodes were then placed in an aqueous solution containing 2% silver nitrate (AgNO₃) (0.5 g), citric acid (0.5 g) and water (20 mL). Cyclic voltammetry was performed on the resulting biosensor systems according to the present invention. For each system, the applied voltage was cycled 15 times from a low potential to a high potential using a potentiostat and then repeated. The voltage potential applied ranged from about −40 mV to about 120 mV with a scan rate of 100 mV/s. During the application of the “low” or negative potential, the Ag image nanoparticles reduced from the aqueous solution and deposited onto to the conductive substrate (the “reduction” phase) at the location of the Au target nanoparticles. During the application of the “high” or positive potential, the deposited Ag nanoparticles oxidized and thus deplated from the conductive substrate and were caused to reenter the solution (the “oxidation” phase). For each reduction-oxidation cycle, the cathodic current was measured.

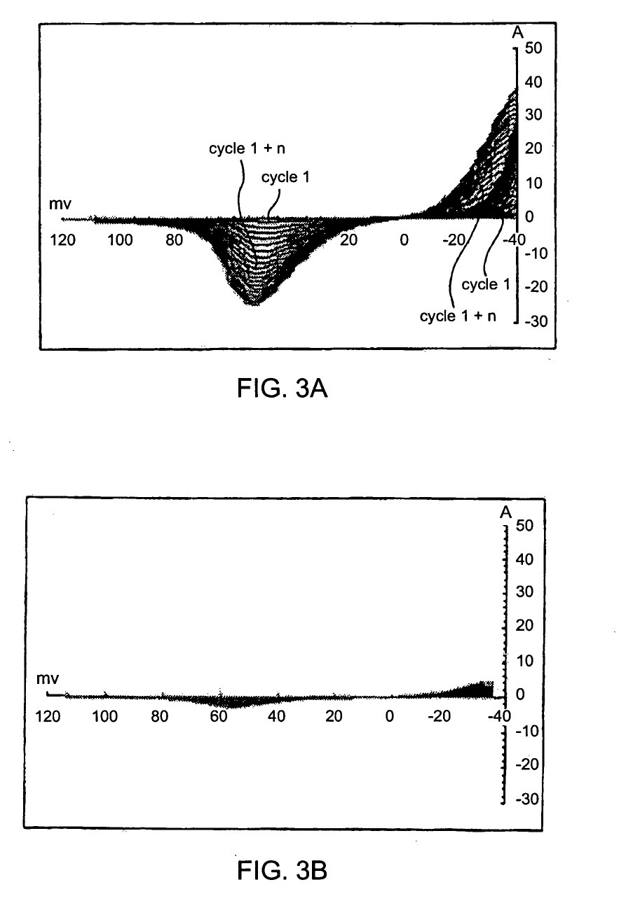

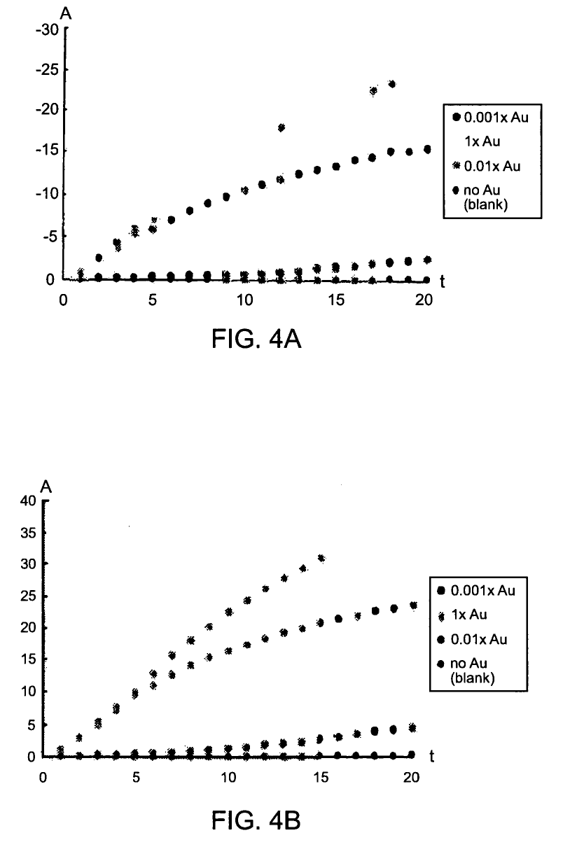

The applied voltages and resulting current measurements for each of the biosensor systems are provided in the graphs of FIGS. 3A and 3B, respectively. The amount of measured current is proportional to the deposition rate of the silver image nanoparticles, while the amount of charge measured is proportional to the amount of deposited silver image nanoparticles on the ITO conductive substrate. In both cases, the image nanoparticle deposition current (the positive current) and the image nanoparticle dissolution current (the negative current) proportionately increase with each cycle. This progressive increase in deposition and dissolution currents indicates that the amount of image nanoparticles deposited during each cycle correspondingly increases. For example, as illustrated in FIG. 3A, the deposition and dissolution currents for a first voltammetric cycle (cycle 1) are approximately −2 mA and 2 mA, respectively, and respectively increase in magnitude at about 2 mA per cycle for additional cycles (cycle 1+n). FIGS. 4A and 4B illustrate the deposition current and dissolution current, respectively, as a function of time.

Thus, when a negative potential is applied to the conductive surface upon with the Au target nanoparticles are deposited, certain of the Au target nanoparticles become active nucleation points for electrochemical reactions with the Ag image nanoparticles. Once a nucleation point is activated, it remains active while other previously inactive target nanoparticles become activated as nucleation points in subsequent voltammetric cycles. As such, the peaks of reduction and oxidation of the Ag image nanoparticles grow with each voltammetric cycle. The cycling process may be terminated after the application of a low potential or a reduction phase, thus leaving the Ag image nanoparticles at the nucleation points. This outcome is desirous where the nucleation points are to be imaged. If imaging is not necessary or desired, the cycling process may be terminated after the application of a high potential or an oxidation phase, thus removing the deposited Ag image nanoparticles from the nucleation points.

The preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

1. A method of electrochemical imaging, said method comprising:
providing at least one target complex disposed on a conductive substrate;
exposing said at least one target complex to a solution of image nanoparticles;
applying a voltage to said conductive support wherein said image nanoparticles are caused to deposit on said at least one target complex to form at least one image complex; and
repeating said application of voltage.

2. The method of claim 1 further comprising detecting said at least one image complex.

3. The method of claim 2, wherein said detecting said at least one image complex comprises using an imaging technique.

4. The method of claim 2, wherein said detecting said at least one image complex comprises using an electronic measurement technique.

5. The method of claim 2, wherein said detecting said at least one image complex comprises using a mass measurement technique.

6. The method of claim 1, wherein said target complex comprises a target biomolecule and a target nanoparticle.

7. The method of claim 6, wherein said target nanoparticle comprises gold.

8. The method of claim 6, wherein said image nanoparticle comprises of silver.

9. The method of claim 1, wherein said voltage is in the range from about −2000 mV to about 2000 mV.

10. The method of claim 1, wherein said voltage is applied between about 5 and about 50 times.

11. The method of claim 1, wherein said providing at least one target complex comprises:
forming said at least one target complex; and
disposing the at least one target complex onto said conductive substrate.

12. The method of claim 1, wherein said providing at least one target complex comprises:
disposing a target biomolecule onto said conductive substrate; and
contacting said target biomolecule with a target nanoparticle to form said target complex on said first conductive substrate.

13. A method of determining the presence of a biomolecule, said method comprising:
providing a plurality of target complexes disposed on a conductive substrate, each said target complex comprising a target biomolecule and a target nanoparticle;
exposing said plurality of target complexes to a solution of image nanoparticles;
applying a voltage to said conductive support wherein said image nanoparticles are caused to deposit on said plurality of target complexes to form a plurality of image complexes; and
repeating said application of voltage at least once.

14. The method of claim 13, further comprising:
detecting said plurality of image complexes;
determining whether the detected plurality of image complexes provides a sufficient image of said biomolecules; and
repeating said application of voltage at least once upon a determination that said image of said biomolecules is insufficient.

15. The method of claim 14, wherein said detecting said plurality of image complexes comprises using an imaging technique.

16. The method of claim 14, wherein said detecting said plurality of image complexes comprises using an electronic measurement technique.

17. The method of claim 14, wherein said detecting said plurality of image complexes comprises using a mass measurement technique.

18. The method of claim 13, wherein said providing said plurality of target complexes comprises:
forming said plurality of target complexes; and
disposing said plurality of target complexes onto said conductive substrate.

19. The method of claim 13, wherein said providing said plurality of target complexes comprises:
disposing a plurality of target biomolecules onto said conductive substrate; and
contacting said plurality of target biomolecules with a plurality of target nanoparticles to form said plurality of target complexes on said first conductive substrate.

20. The method of claim 13, wherein said target nanoparticles are made of gold.

21. The method of claim 13, wherein said image nanoparticles are made of silver.

22. The method of claim 13, wherein said application of voltage comprises a voltage in the range from about −1500 mV to about 1500 mV.

23. The method of claim 13, wherein said voltage is applied between about 5 and about 50 times.

24. A method comprising:
(a) providing a plurality of target complexes disposed on a conductive substrate, each said target complex comprising a target biomolecule and a target nanoparticle;
(b) exposing said plurality of target complexes to a solution containing a plurality of image nanoparticles;
(c) applying a relatively low voltage to said conductive support wherein said image nanoparticles are caused to deposit on at least one of said plurality of target complexes to form at least a first nucleation point;
(d) applying a relatively high voltage to said conductive support wherein said image nanoparticles are removed from said at least first nucleation point; and
(e) repeating (c) and (d) as desired to cause the deposition of said image nanoparticles on said first nucleation point and on additional target complexes to cumulatively form additional nucleation points.

25. The method of claim 24, further comprising:
terminating the repetition of voltage application immediately after the application of a low voltage.

26. The method of claim 24, comprising:
terminating the application of voltage immediately after the application of a high voltage.

27. The method of claim 24, further comprising:
detecting said image nanoparticles deposited at said nucleation points.

28. An electrochemical imaging system, comprising:
a conductive substrate configured for the formation of at least one image complex thereon; and
a voltage supply having electrodes for electrical connection to said conductive substrate, wherein said voltage supply is configured to apply a voltage to said conductive substrate repeatedly between a relatively low voltage and a relatively high voltage whereby said at least one image complex is formed when image nanoparticles are exposed to at least one target complex deposited on said conductive substrate.

29. The system of claim 28, further comprising:
means for detecting said at least one image complex, said means selected from imaging equipment, electronic measurement equipment and mass measurement equipment. a supply of target complexes.

30. A kit for electrochemical imaging of image complexes, said kit comprising:
a supply of target complexes for deposition on said conductive substrate of the system of claim 28; and
a supply of image nanoparticles configured for interaction with said supply of target complexes.
